(19) United States
(12) Patent Application Publication
(10) Pub. No.: US 2005/0121500 A1
(43) Pub. Date: Jun. 9, 2005

(54) Method for producing a soldered joint between a substrate and a contact element of a fuel cell unit

(75) Inventors: Peter Schenk, Hohenstein (DE); Hans-Rainer Zerfass, Taunusstein (DE)

Correspondence Address: EDWARD J. TIMMER, P. O. BOX 770, RICHLAND, MI, 49083, US

(73) Assignee: ElringKlinger AG

(21) Appl. No.: 10/941,413

(22) Filed: Sep. 15, 2004

(30) Foreign Application Priority Data
Sep. 20, 2003 (DE) 103 43 652.9

(51) Int. Cl. B23K 31/00

(52) U.S. Cl. 228/248.1

(57) ABSTRACT

In order to provide a method for producing a soldered joint between a substrate for at least one electrode and a contact element of a fuel cell unit which results in the substrate being reliably soldered to the contact element but without impairing the functioning of the substrate by surplus solder material, it is proposed that the method comprise the following process steps: applying a mixture, which comprises a soldering material and a bonding agent containing an elastomer material and/or a resin, to the contact element and/or the substrate; bringing the substrate and the contact element into contact; soldering the substrate and the contact element by heating them up to a soldering temperature.

The present disclosure refers to the subject matter disclosed in the German patent application No. 103 43 652.9 of 20 Sep. 2003. The entire description of this earlier application is incorporated herein as part of the present description by reference thereto (“incorporation by reference”).

### BACKGROUND OF THE INVENTION

The present invention relates to a method for producing a soldered joint between a substrate for at least one electrode and a contact element of a fuel cell unit.

When manufacturing fuel cell units for high temperature fuel cells, use is made of a substrate consisting of a wire fleece or a wire mesh for example upon which a cathode-electrolyte-anode unit is produced by, for example, initially forming the anode by means of a vacuum plasma spraying process whereafter the electrolyte and then the cathode are sprayed on. The individual sprayed; coatings are of a ceramic nature, the electrolyte is a high temperature ion conductor.

In order to enable the fuel gas to reach the anode through the substrate, the substrate must on the one hand be sufficiently porous but must also be sufficiently mechanically stiff on the other because it serves as an integrated carrier for the cathode-electrolyte-anode unit (CEA unit).

Between the substrate and the CEA unit of a neighbouring fuel cell unit, there is arranged a contact element in the form of a “bipolar plate” through which a current of several hundred amperes flows when the high temperature fuel cell is operative, for which reason it is necessary have a secure, laminar and highly conductive connection between the substrate and the contact element.

It is known from DE 198 36 351 A1 that a soldered joint between the substrate and the contact element can be formed by applying a soldering foil or a screen print consisting of a high temperature solder between the substrate and the contact element prior to the assembly of the fuel cell unit. In order to prevent the foil from slipping during the process of manipulating the substrate and the contact element, the soldering foil is fixed in position relative to the contact element by a spot welding process. The soldering of the substrate to the contact element subsequently takes place in a vacuum oven.

At the soldering temperature however, the solder is highly liquefied so that a surplus of solder material rises up to the surface of the substrate remote from the contact element due to capillary action in the substrate. The gas permeability of the substrate is thereby impaired.

Consequently, the object of the present invention is to provide a method of producing a soldered joint between the substrate and the contact element of a fuel cell unit which results in the substrate being reliably soldered to the contact element but without impairing the functioning of the substrate by surplus solder material.

### SUMMARY OF THE INVENTION

This object is achieved in accordance with the invention by a method for producing a soldered joint between a substrate for at least one electrode and a contact element of a fuel cell unit, which comprises the following process steps:
applying a mixture, which comprises a soldering material and a bonding agent containing an elastomer material and/or a resin, to the contact element and/or the substrate;
bringing the substrate and the contact element into contact;
soldering the substrate and the contact element by heating them up to a soldering temperature.

The concept underlying the solution in accordance with the invention is that the solder material is not applied to the contact element and/or the substrate in a pure form in the form of a soldering foil, but rather that it is applied in diluted form in a mixture which, in addition to the solder material, comprises a bonding agent that contains an elastomer material and/or a resin.

By appropriate selection of the proportion of solder material in the mixture, the quantity of solder material applied to the contact element and/or the substrate can be adjusted in a simple manner in such a way that an adequate soldered connection between the substrate and the contact element is produced without superfluous solder ascending through the substrate by capillary action during the process of heating the arrangement up to the soldering temperature.

The proportion of solder material in the mixture can be adjusted to any arbitrary value.

By virtue of the bonding agent which contains an elastomer material and/or a resin, the effect is achieved on the one hand that the mixture will have a paint-like and/or fluid consistency so that it can easily be applied to the contact element and/or the substrate, whilst on the other hand, it will have a sufficiently high viscosity as to prevent the solder material from settling in the mixture.

Furthermore, the mixture adheres to the contact element and/or to the substrate without requiring an additional working step for fixing the solder material to the contact element or to the substrate such as, for instance, the welding of the soldering foil in the known soldering methods.

The method in accordance with the invention is suitable in particular for producing a soldered joint between the substrate for the CEA unit and a contact element of a high temperature fuel cell.

In a preferred embodiment of the method in accordance with the invention, provision is made for the bonding agent to contain an acrylic rubber and/or an acrylic resin.

Furthermore, provision may be made for the mixture to comprise a solvent in addition to the solder material and the bonding agent.

In particular, butoxyl can be used as the solvent.

It has proved to be particularly expedient if the mixture is applied to the contact element and/or the substrate in the form of a paste.

The application of the mixture to the contact element and/or the substrate can be effected, in particular, by a spraying, pouring, rolling or wiping process.

The quantity of the mixture applied and thus the quantity of the solder material applied can be further reduced by not applying the mixture over the entire surface of the contact element or the substrate, but only over partial areas of these surfaces which form an arbitrary predetermined application pattern.

In order to enable such an arbitrary predetermined pattern to be produced, provision may be made, in particular, for the mixture to be applied to the contact element and/or the substrate by a pattern printing process, especially by a screen printing, template printing or pad printing process.

In order to keep the quantity of solder that is applied as small as possible, the mixture is preferably applied to the contact element and/or the substrate in such a manner that a continuous layer of the mixture is not formed on the contact element and/or on the substrate.

In a preferred embodiment of the method in accordance with the invention, provision is made for the solder material to contain a high temperature metal solder, and preferably to consist entirely of the high temperature metal solder.

Furthermore, it has proven to be expedient if the solder material contains a, preferably metallic, solder powder, and in particular, if it consists entirely of the solder powder.

In particular, the metallic solder powder can comprise a nickel based solder powder and/or an iron based solder powder.

In order to prevent the penetration of surplus solder material into the substrate, it has proved to be expedient if the proportion of the solder material in the mixture amounts to at most approximately 60 percent by weight, but preferably to less than 50 percent by weight.

On the other hand, it has proved to be expedient for achieving a mechanically stable and sufficiently electrically conductive connection between the substrate and the contact element if the proportion of the solder material in the mixture amounts to at least approximately 10 percent by weight.

The substrate used preferably comprises a knitted metal wire fabric, a woven metal wire cloth, a metal wire mesh, a metal wire fleece and/or a porous body consisting of sintered or compressed metal particles.

The metal wire used can, for example, be formed from a high temperature resistant steel, and in particular, from the steel bearing the Material No. 1,4742 (according to SEW 470) which has the following composition: 0.08 percent by weight C, 1.3 percent by weight Si, 0.7 percent by weight Mn, 18.0 percent by weight Cr, 1.0 percent by weight Al, the remainder of iron.

As an alternative thereto, the metal wire used can be formed for example from the material Crofer 22 which has the following composition: 22 percent by weight Cr, 0.6 percent by weight Al, 0.3 percent by weight Si, 0.45 percent by weight Mn, 0.08 percent by weight Ti, 0.08 percent by weight La, the remainder of Fe. This ferrous alloy material is sold by the company Thyssen Krupp VDM GmbH, Plettenberger Str 2, 58791 Werdohl, Germany.

In particular, provision may be made for the substrate to consist substantially of the knitted metal wire fabric, the woven metal wire cloth, the metal wire mesh, the metal wire fleece and/or the porous body consisting of sintered or compressed metal particles.

In a preferred embodiment of the method in accordance with the invention, provision is made for the contact element to comprise a bipolar plate.

It is particularly expedient, if the contact element not only serves for the production of an electrically conductive connection between the substrate of a fuel cell unit and the CEA unit of a neighbouring fuel cell unit, but if, at the same time, it forms a housing member of a housing for the fuel cell unit.

Furthermore, provision may be made for the contact element to be connected to a housing member of the fuel cell unit in a substantially gas-tight manner, and in particular, be welded and/or soldered thereto.

The substrate is also preferably connected along its edge to a housing member of the fuel cell unit in a substantially gas-tight manner, and in particular, is welded and/or soldered thereto.

The process of soldering the substrate and the contact element is preferably effected in a vacuum or in an inert gas atmosphere, in particular, in an argon or a nitrogen atmosphere.

Claim 19 is directed to a fuel cell unit which comprises a substrate, an electrode arranged on one face of the substrate and a contact element arranged on the side of the substrate remote from the electrode, said contact element being soldered to the substrate by a solder material in accordance with the method according to the invention, whereby the surface of the substrate remote from the contact element is substantially free from the solder material.

Due the absence of solder material on the electrode side of the substrate, it is possible, in particular, to obtain an even coating of the electrode material on the substrate.

Further features and advantages of the invention form the subject matter of the following description and the sketched illustration of exemplary embodiments.

### BRIEF DESCRIPTION OF THE DRAWING

FIG. 1 shows a detail from a schematic cross section through a fuel cell unit incorporating a substrate, a cathode-electrolyte-anode unit located on the substrate, a housing upper part welded to an edge of the substrate and a housing lower part soldered to the lower surface of the substrate.

### DETAILED DESCRIPTION OF THE INVENTION

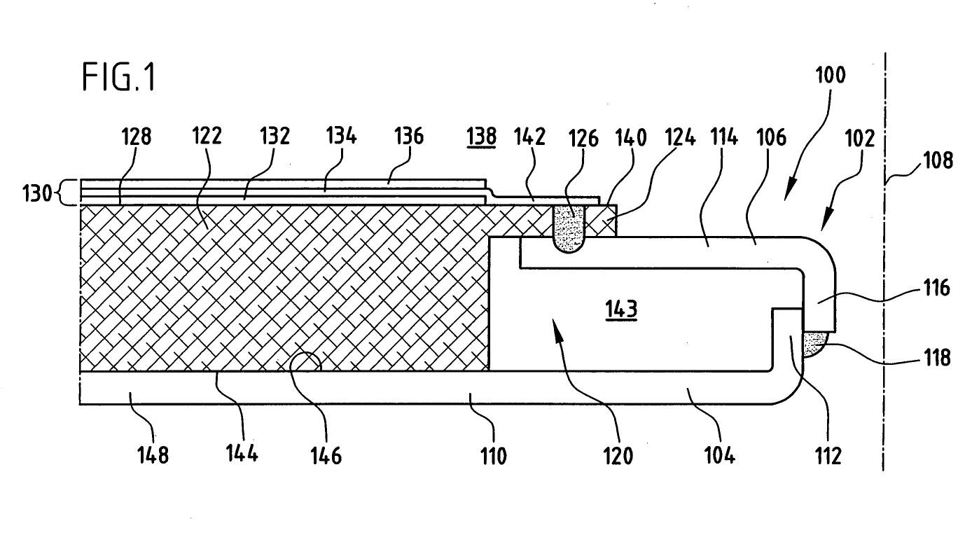

A fuel cell unit bearing the general reference 100 which is illustrated schematically in FIG. 1 comprises a housing 102 which is composed of a housing upper part 106 and a housing lower part 104.

The housing lower part 104 is in the form of a shaped part made of sheet metal and comprises a plate 110 which is aligned substantially perpendicularly relative to the direction 108 of a pile whilst the edges thereof blend into an edge flange 112 which is bent up substantially parallel to the pile direction 108.

The housing upper part 106 is likewise in the form of a shaped part made of sheet metal and comprises a plate 114 which is aligned substantially perpendicularly relative to the pile direction 108, whilst the edges thereof blend into an edge flange 116 which is bent over substantially parallel to the pile direction 108 and which points towards the housing lower part 104 and laps over the edge flange 112 of the housing lower part 104.

The edge flange 116 of the housing upper part 106 is connected in gas-tight manner to the edge flange 112 of the housing lower part 104 along a peripheral welding seam 118.

The housing upper part 106 and the housing lower part 104 are preferably made of a rustproof chromium-nickel stainless steel.

The housing upper part 106 incorporates a substantially rectangular passage opening 120 into which a substantially block-shaped substrate 122 is inserted

The substrate 122 may, for example, be in the form of a knitted metal fabric, a woven metal cloth, a metal braiding, a metal fleece and/or a porous body consisting of sintered or compressed metal particles.

The substrate 122 has an edge portion 124 which extends along the edges of the substrate 122, overlaps the region of the housing upper part 106 bordering the passage opening 120 and rests flatly on the housing upper part 106 from above.

The edge portion 124 of the substrate 122 is connected to the metallic material of the housing upper part 106 in gas-tight manner by a welding process, for example, by a laser welding, an electron-beam welding, a projection welding or a capacitor discharge welding process. A gas-tight zone 126 is formed in the edge portion 124 of the substrate 122 by means of the welding process, said zone extending over the entire height of the edge portion 124 and forming a gas-tight barrier which extends around the entire periphery of the substrate 122.

On the upper surface 128 of the substrate 122, there is arranged a cathode-electrolyte-anode unit (CEA unit) 130 which comprises an anode 132 that is arranged directly on the upper surface 128 of the substrate 122, an electrolyte 134 arranged above the anode 132 and a cathode 136 arranged above the electrolyte 134.

The anode 132 is formed from a ceramic material which is electrically conductive at the operating temperature and consists of ZrO₂ or of a Ni—ZrO₂-Cermet (ceramic and metal mixture) for example, and which is porous in order to enable a fuel gas passing through the substrate 122 to have access through the anode 132 to the electrolyte 134 bordering on the anode 132.

For example, a hydrocarbon-containing gas mixture or pure hydrogen can be used as the fuel gas.

The electrolyte 134 is preferably in the form of a solid electrolyte and may consist of yttrium-stabilized zirconium dioxide for example.

The cathode 136 is made of a ceramic material which is electrically conductive at the operating temperature and consists of (La_{0.8}Sr_{0.2})_{0.98} MnO₃ for example, and which is porous in order to enable an oxidizing agent, for example air or pure oxygen from an oxidizing agent region 138 bordering on the cathode 136, to have access to the electrolyte 134.

The gas-tight electrolyte 134 extends beyond the edge of the gas-permeable anode 132 and beyond the edge of the gas-permeable cathode 136 whilst the lower surface thereof rests directly on the upper surface 140 of the edge portion 124 of the substrate 122. This outer portion 142 of the electrolyte 134 that is arranged directly on the substrate 122 extends outwardly relative to the edge of the substrate 122 to such an extent that it covers the gas-tight zone 126 and, in consequence, the fuel gas chamber 143 of the fuel cell unit 100 formed by the inner part of the substrate 122 and the intermediary space between the housing lower part 104 and the housing upper part 106 is separated in gas-tight manner from the oxidizing agent region 138 located above the electrolyte 134.

The lower surface 144 of the substrate 122 is soldered to the upper surface 146 of the housing lower part 104 in order to establish a mechanical and electrically conductive connection between the substrate 122 and the housing lower part 104.

For the purposes of assembling a fuel cell pile, a plurality of the previously described fuel cell units 100 are stacked upon one another in the pile direction 108, whereby each housing lower part 104 of a fuel cell unit 100 is in electrically conductive contact with the cathode 136 of the neighbouring fuel cell unit 100 that is located therebelow in the pile direction 108.

The housing lower part 104 of each fuel cell unit 100 thus serves as a so-called “bipolar plate” or “interconnector plate” and thus acts as a contact element 148 by means of which the CEA units 130 of the successive fuel cell units 100 in the pile direction 108 are in electrically conductive contact with one another.

In operation of the fuel cell device formed by the pile of fuel cell units 100, the CEA unit 130 of each fuel cell unit 100 has a temperature of approximately 850° C for example, at which the electrolyte 134 is conductive for oxygen ions. The oxidizing agent from the oxidizing agent region 138 extracts electrons from the cathode 136 and delivers bivalent oxygen ions to the electrolyte 134 which then migrate through the electrolyte 134 to the anode 132. The fuel gas from the fuel gas chamber 143 is oxidized at the anode 132 by the oxygen ions from the electrolyte 134 and thereby delivers electrons to the anode 132.

The contact element 148 of each fuel cell unit 100 serves for removing the electrons that were freed by the reaction at the anode 132 from the anode 132 via the substrate 122 and for supplying the electrons needed for the reaction at the cathode 136 to the cathode 136 of the neighbouring fuel cell unit 100.

Consequently, when the fuel cell device is operative, a current having an amperage of several hundred amperes flows via the substrate 122 and the housing 104 of the fuel cell unit 100 serving as a contact element 148, for which reason a secure, laminar and highly conductive connection between the substrate 122 and the housing lower part 104 is necessary.

This electrically conductive connection between the substrate 122 and the housing lower part 104 is produced as follows:

Firstly, a solder powder is made from a suitable solder alloy.

Compositions of suitable high temperature solder alloys are indicated in DE 44 43 430 A1 for example. In particular, the following compositions for solder alloys are indicated in the aforementioned specification:
Composition 1: 0 to 35 percent by weight Cr, 0 to 10 percent by weight Si, 0 to 3 percent by weight B, 0 to 6 percent by weight Co, 0 to 5 percent by weight P, 0 to 15 percent by weight Fe, 0 to 8 percent by weight of the sum of the elements Ti, Zr, Nb, V, Hf, W, Mo, 0 to 5 percent by weight Al, 0 to 2 percent by weight of the elements Ce, La, Sr, the remainder Ni;
Composition 2: 10 to 35 percent by weight Cr, 8 to 35 percent by weight Ni, 0 to 10 percent by weight Si, 0 to 5 percent by weight B, 0 to 6 percent by weight Co, 0 to 10 percent by weight P, 0 to 6 percent by weight of the sum of the elements Ti, Zr, Nb, Ta, V, Hf, W, Mo, 0 to 5 percent by weight Al, 0 to 8 percent by weight of the sum of the elements Ce, La, Sr, the remainder Fe;
Composition 3: 0 to 35 percent by weight Cr, 8 to 35 percent by weight Ni, 0 to 10 percent by weight Si, 0 to 6 percent by weight B, 0 to 6 percent by weight P, 0 to 8 percent by weight of the elements Ti, Zr, Nb, Ta, Hf, V, W, Mo, 0 to 5 percent by weight Al, 0 to 8 percent by weight of the sum of the elements Ce, La, Sr, the remainder Co;
Composition 4: 0 to 10 percent by weight Cr, 0 to 18 percent by weight Ni, 0 to 6 percent by weight of the elements Ti, Zr, Nb, Ta, Hf, V, Mo, Al, the remainder Au;
Composition 5: 0 to 5 percent by weight Cr, 0 to 40 percent by weight Ni, 0 to 10 percent by weight Au, 0 to 5 percent by weight of the sum of the elements Ti, Zr, Nb, Ta, Hf, V, Mo, the remainder Pd.

Furthermore, as a suitable solder powder, use can be made, in particular, of the brazing solder powder which is sold under the name “AMS 4777F Braze Powder” by the company HTK Hamburg GmbH, Woelckenstrasse 11, D22393 Hamburg, Germany.

This solder powder has the following composition: 7.0 percent by weight Cr, 3.0 percent by weight Fe, 4.5 percent by weight Si, 3.0 percent by weight B, the remainder Ni.

As an alternative or supplement thereto, an iron based solder powder which has the following composition: 5.0 percent by weight Si, 4.0 percent by weight B, the remainder being Fe can also be used as a solder powder.

Such an iron based solder powder can be procured from the company Wesgo Ceramics GmbH, Willi-Grassner Str. 11, 91056 Erlangen, Germany.

The solder powder is mixed with a bonding agent such as an acrylic rubber and/or an acrylic resin for example, and with a solvent such as butoxyl for example, so as to form a paste.

In the following, four recipes of such a solder paste are indicated in exemplary manner:

Recipe 1:

| | |
|---|---|
| Solder powder (for example AMS 4777F Braze | 9 parts by weight |
| Powder) | |
| A solution of 10 percent by weight acrylic rubber | 10 parts by weight |
| in 90 percent by weight butoxyl | |

As an acrylic rubber, use can be made, in particular, of the acrylic rubber which is sold under the name “Nipol AR 12” by the company Zeon Europe GmbH, Niederkasseler Lohweg 177, D-40547 Dusseldorf, Germany.

In this recipe, the proportion of the solder powder in the solder paste mixture amounts to approximately 47 percent by weight.

Recipe 2:

| | |
|---|---|
| Solder powder (for example AMS 4777F Braze | 6 parts by weight; |
| Powder) | |
| A solution of 10 percent by weight acrylic rubber | 40 parts by weight |
| in 90 percent by weight butoxyl | |

As an acrylic rubber, use can be made, in particular, of the acrylic rubber which is sold under the name “Nipol AR 12” by the company Zeon Europe GmbH.

In this recipe, the proportion of the solder powder in the solder paste mixture amounts to approximately 13 percent by weight.

Recipe 3:

| | |
|---|---|
| Solder powder (for example AMS 4777F Braze | 8 parts by weight; |
| Powder) | |
| A solution of 10 percent by weight acrylic rubber | 20 parts by weight |
| in 90 percent by weight butoxyl | |

As an acrylic rubber, use can be made, in particular, of the acrylic rubber which is sold under the name “Nipol AR 12” by the company Zeon Europe GmbH.

In this recipe, the proportion of the solder powder in the solder paste mixture amounts to approximately 29 percent by weight.

Recipe 4:

| | |
|---|---|
| Solder powder (for example AMS 4777 F Braze | 200 parts by weight; |
| Powder) | |
| A solution of 20 percent by weight acrylic resin | 50 parts by weight |
| in 80 percent by weight butoxyl | |

As an acrylic resin, use can be made, in particular, of the acrylic resin which is sold under the name Paraloid B-67 100% by the company Rohm and Haas (UK) Limited, Lenning House, 2 Masons Avenue, Croydon, Surrey, CR9 3NB, Great Britain.

This recipe is suitable, in particular, for application to the contact element and/or the substrate by a spraying process.

In each of the four recipes, use is preferably made of a solder powder which incorporates particles up to a size of at most approximately 110 82 m.

Such a solder powder can be produced by a sieving process using a sieve having a mesh-size of Mesh 140.

Furthermore, a preferably silicon-free polymer antifoaming agent in a proportion of approximately 0.5 percent by weight to approximately 1 percent by weight of the solder paste for example can be added in each of the recipes mentioned hereinabove. A suitable polymer antifoaming agent, which contains a solution of a polyacrylate, is sold under the name “Byk 051” by the company BYK-Chemie, Abelstr. 45, D-46462 Wesel, Germany for example.

The solder paste produced in the manner described is coated onto the upper surface 146 of the housing lower part 104 and/or on the lower surface 144 of the substrate 122.

Hereby, the application of the solder paste can be effected by a rolling process, a blade-coating process, or by spraying and/or pouring the solder paste for example.

The quantity of the solder paste applied can be reduced by not applying the solder paste over the entire upper surface of the housing lower part 146 or not over the entire lower surface 144 of the substrate 122, but only over partial areas of one of these surfaces or of both surfaces, these areas forming an arbitrary predetermined application pattern.

For example, the solder paste can be applied in such an arbitrary predetermined application pattern by means of a pattern printing process, especially a screen printing, template printing or pad printing process.

A silk-screen printing process which has proved to be particularly suitable is accomplished using sieves T12 to T18 (having a mesh size of approximately 300 μm to approximately 700 μm) of polyester weave.

In order to keep the quantity of solder that is applied as small as possible, the quantity of the solder paste mixture that is used for the coating process is preferably such that a continuous layer of solder paste is not formed on the surface which is coated with the solder paste, but rather, that there is merely an accumulation of mutually non-adherent solder paste agglomerates thereon.

After the solder paste mixture has been applied to the housing lower part 104 or to the substrate 122, the substrate 122 is inserted into the passage opening 120 of the housing upper part 106 and brought into contact with the housing lower part 104.

Subsequently, the applied solder paste mixture is submitted to a drying process at a temperature within a range of about 80° C. to approximately 120° C. for a drying time of approximately 10 minutes for example.

After the drying process, the edge portion 124 of the substrate 122 is welded to the housing upper part 106 and the housing upper part 106 is welded to the housing lower part 104.

Thereafter, the process of soldering the substrate 122 to the housing lower part 104 takes place in a vacuum or in an inert gas atmosphere, in particular, in an argon or a nitrogen atmosphere.

For the purposes of the soldering process, the group of components comprising the substrate 122 and the housing lower part 104 is heated in an oven to a temperature of e.g. approximately 1,100° C. at which the solder powder is liquefied.

By appropriate choice of the correct part by weight of the solder powder in the solder paste mixture and by appropriate choice of the quantity of the solder paste mixture applied, it is thereby ensured that adequate soldering of the substrate 122 to the housing lower part 104 takes place without superfluous solder ascending by capillary action in the porous substrate 122 to the upper surface 128 thereof.

Consequently, the finished soldered substrate 122 does not have any solder material on or in the vicinity of its upper surface 128.

After the substrate 122 and housing lower part 104 have been soldered, the CEA unit 130 is then produced on the upper surface 128 of the substrate 122 by a vacuum plasma spraying process for example.

1. A method for producing a soldered joint between a substrate for at least one electrode and a contact element of a fuel cell unit, comprising the following process steps:
applying a mixture, which comprises a solder material and a bonding agent containing an elastomer material and/or a resin, to the contact element and/or the substrate;
bringing the substrate and the contact element into contact;
soldering the substrate and the contact element by heating them up to a soldering temperature.

2. A method in accordance with claim 1, wherein the bonding agent contains an acrylic rubber and/or an acrylic resin.

3. A method in accordance with claim 1, wherein the mixture comprises a solvent.

4. A method in accordance with claim 3, wherein the solvent contains butoxyl.

5. A method in accordance with claim 1, wherein the mixture is applied to the contact element and/or the substrate in the form of a paste.

6. A method in accordance with claim 1, wherein the mixture is applied to the contact element and/or the substrate by a spraying process, a pouring process, a rolling process or a wiping process.

7. A method in accordance with claim 1, wherein the mixture is applied to the contact element and/or the substrate by a pattern printing process, in particular, by a screen printing process, a template printing process or a pad printing process.

8. A method in accordance with claim 1, wherein the mixture is applied to the contact element and/or the substrate in such a manner that a continuous layer of the mixture is not formed on the contact element and/or on the substrate.

9. A method in accordance with claim 1, wherein the solder material contains a high temperature metal solder.

10. A method in accordance with claim 1, wherein the solder material contains a, preferably metallic, solder powder.

11. A method in accordance with claim 1, wherein the proportion of the solder material in the mixture amounts to at most approximately 60 percent by weight, preferably to less than 50 percent by weight.

12. A method in accordance with claim 1, wherein the proportion of the solder material in the mixture amounts to at least approximately 10 percent by weight.

13. A method in accordance with claim 1, wherein the substrate comprises a knitted metal wire fabric, a woven metal wire cloth, a metal wire mesh, a metal wire fleece and/or a porous body consisting of sintered or compressed metal particles.

14. A method in accordance with claim 1, wherein the contact element comprises a bipolar plate.

15. A method in accordance with claim 1, wherein the contact element forms a housing member of a housing for the fuel cell unit.

16. A method in accordance with claim 1, wherein the contact element is connected to a housing member of the fuel cell unit in a substantially gas-tight manner, and in particular, is welded and/or soldered thereto.

17. A method in accordance with claim 1, wherein the substrate is connected along the edge thereof to a housing member of the fuel cell unit in a substantially gas-tight manner, and in particular, is welded and/or soldered thereto.

18. A method in accordance with claim 1, wherein the process of soldering the substrate and the contact element is effected in a vacuum or in an inert gas atmosphere, in particular, in an argon or a nitrogen atmosphere.

19. A fuel cell unit, comprising a substrate,
an electrode arranged on one face of the substrate and
a contact element which is arranged on the side of the substrate remote from the electrode and is soldered to the substrate by a solder material in accordance with the method according to claim 1,
whereby the surface of the substrate remote from the contact element is substantially free from the solder material.
